(19) United States
(12) Patent Application Publication
(10) Pub. No.: US 2012/0158555 A1
(43) Pub. Date: Jun. 21, 2012

(54) METHODS, APPARATUS, SYSTEMS AND COMPUTER READABLE MEDIUMS FOR USE IN ASSOCIATION WITH PURCHASING ACTIVITIES

(76) Inventors: Martina Rothley, Schwetzingen (DE); Carmen Blaum, Bodenheim (DE)

(21) Appl. No.: 12/971,274

(22) Filed: Dec. 17, 2010

(51) Int. Cl. G06Q 40/00; G06Q 10/00

(52) U.S. Cl. 705/30

(57) ABSTRACT

According to some embodiments, a method comprises: receiving, by a processing system, data indicative of purchasing activities; displaying, by a processing system, a summary of at least a portion of the purchasing activities; receiving, by a processing system, a user request to simulate a change to the at least a portion of the purchasing activities; determining, by a processing system, at least one result of the simulated change to the at least a portion of the purchasing activities; displaying, by a processing system, the at least one result of the simulated change to the at least a portion of the purchasing activities; receiving, by a processing system, a user request to store data indicative of the at least one result; and storing, by a processing system, data indicative of the at least one result in association with the data indicative of the purchasing activities.

### FIELD

Some embodiments of the present invention relate to methods, apparatus, systems and/or computer readable mediums for use in association with purchasing activities

### BACKGROUND

Businesses and/or other entities often purchase goods and/or services in the course of their operations. Many of such businesses and/or other entities employ one or more processing systems in association with such purchasing activity. For example, some businesses and/or other entities employ a supplier relationship management (SRM) system and/or an enterprise resource planning (ERP) system to provide functions related to the creation, tracking and/or storage of purchase orders.

### SUMMARY

From time to time, it may be desirable to explore the potential for savings in purchasing activities.

Thus, it would be desirable to provide a system that can be used to help explore such potential.

However, it would also be desirable to provide a system that helps lead to actual savings, rather than merely identifying potential savings. Thus, a system that helps lead to actual savings, rather than merely potential savings, would also be desirable.

To this effect, it has been determined that It would be helpful to store data that identifies potential savings in association with data indicative of the purchasing activities.

It has also been determined that it would be helpful to evaluate and reward employees on the basis of whether the potential savings are actually achieved.

In one aspect, a method comprises: receiving, by a processing system, data indicative of purchasing activities; displaying, by a processing system, a summary of at least a portion of the purchasing activities; receiving, by a processing system, a user request to simulate a change to the at least a portion of the purchasing activities; determining, by a processing system, at least one result of the simulated change to the at least a portion of the purchasing activities; displaying, by a processing system, the at least one result of the simulated change to the at least a portion of the purchasing activities; receiving, by a processing system, a user request to store data indicative of the at least one result; and storing, by a processing system, data indicative of the at least one result in association with the data indicative of the purchasing activities.

In some embodiments, the at least one result comprises: an estimate of potential savings from the simulated change to the at least a portion of the purchasing activities; and the storing comprises: storing data indicative of the estimate of potential savings in association with the data indicative of the purchasing activities.

In some embodiments, the data indicative of purchasing activities comprises a data object defining a contract with a supplier; and wherein the storing comprises: storing the data indicative of the at least one result in the data object defining the contract with a supplier.

In some embodiments, the contract with the supplier comprises a target value for the contract, the at least one result of the simulated change defines a target savings for the contract compared to the target value of the contract; and the storing comprises: storing data indicative of the target savings in the data object defining the contract with the supplier.

In some embodiments, the method further comprises: receiving data indicative of committed savings, compared to the target value of the contract, that are agreed to by the supplier; and storing the data indicative of the amount savings that is agreed to by the supplier in the data object defining the contract with the supplier.

In some embodiments, the method further comprises receiving data indicative of actual savings over a period of the contract compared to the target value of the contract; and storing the data indicative of the actual amount saved in the data object defining the contract with the supplier.

In some embodiments, the method further comprises generating an evaluation based at least in part on at least one of the target savings, the committed savings and the actual savings.

In some embodiments, the method further comprises storing at least one of the target savings, the committed savings and the actual savings in at least one of an electronic purchasing guide, an electronic supplier negotiation document and a human capital management system.

In some embodiments, the displaying a summary of at least a portion of the purchasing activities comprises: displaying a plurality of product categories and a plurality of monetary amounts, each of the plurality of monetary amounts being associated with a respective one of the plurality of product categories.

In some embodiments, the method further comprises determining the plurality of product categories and the plurality of amounts based at least in part on the data indicative of the purchasing activities.

In some embodiments, the method further comprises: receiving, by a processing system, user input indicative of a selected one of the plurality of product categories; wherein the displaying a summary of at least a portion of the purchasing activities comprises: displaying a description of at least one product that is within the selected product category; and displaying at least one monetary amount that is associated with the at least one product and based at least in part on the data indicative of the purchasing activities.

In some embodiments, the method further comprises: receiving, by a processing system, user input indicative of a selected one of the at least one product; determining a plurality of suppliers of the selected product based at least in part on the data indicative of the purchasing activities; determining a plurality of quantities based at least in part on the data indicative of the purchasing activities, each of the plurality of quantities being associated with a respective one of the plurality of suppliers and being indicative of a quantity of the selected product that is to be procured from the associated supplier; determining a plurality of prices based at least in part on the data indicative of the purchasing activities, each of the plurality of prices being associated with a respective one of the plurality of suppliers and being indicative of at least one price charged by the associated supplier for the selected product; displaying data indicative of the plurality of suppliers, the plurality of quantities and the plurality of prices; and wherein the receiving a user request to simulate a change to the at least a portion of the purchasing activities comprises: receiving a user request to simulate a change to at least one of the plurality of suppliers, the plurality of quantities and/or the plurality of prices.

In another aspect a computer readable storage medium has instructions stored thereon, the instructions being executable by a machine to result in a method comprising: receiving, by a processing system, data indicative of purchasing activities; displaying, by a processing system, a summary of at least a portion of the purchasing activities; receiving, by a processing system, a user request to simulate a change to the at least a portion of the purchasing activities; determining, by a processing system, at least one result of the simulated change to the at least a portion of the purchasing activities; displaying, by a processing system, the at least one result of the simulated change to the at least a portion of the purchasing activities; receiving, by a processing system, a user request to store data indicative of the at least one result; and storing, by a processing system, data indicative of the at least one result in association with the data indicative of the purchasing activities.

In some embodiments, the at least one result comprises: an estimate of potential savings from the simulated change to the at least a portion of the purchasing activities; and the storing comprises: storing data indicative of the estimate of potential savings in association with the data indicative of the purchasing activities.

In some embodiments, the data indicative of purchasing activities comprises a data object defining a contract with a supplier; and the storing comprises: storing the data indicative of the at least one result in the data object defining the contract with a supplier.

In some embodiments, the contract with the supplier comprises a target value for the contract; the at least one result of the simulated change defines a target savings for the contract compared to the target value of the contract; and the storing comprises: storing data indicative of the target savings in the data object defining the contract with the supplier.

In another aspect, a system comprises: at least one processor to: receive data indicative of purchasing activities; display a summary of at least a portion of the purchasing activities; receive a user request to simulate a change to the at least a portion of the purchasing activities; determine at least one result of the simulated change to the at least a portion of the purchasing activities; display the at least one result of the simulated change to the at least a portion of the purchasing activities; receive a user request to store data indicative of the at least one result; and store data indicative of the at least one result in association with the data indicative of the purchasing activities.

In some embodiments, the at least one result comprises: an estimate of potential savings from the simulated change to the at least a portion of the purchasing activities; and the at least one processor to store data comprises at least one processor to: store data indicative of the estimate of potential savings in association with the data indicative of the purchasing activities.

In some embodiments, the data indicative of purchasing activities comprises a data object defining a contract with a supplier; and the at least one processor to store data comprises at least one processor to: store the data indicative of the at least one result in the data object defining the contract with a supplier.

In some embodiments, the contract with the supplier comprises a target value for the contract, the at least one result of the simulated change defines a target savings for the contract compared to the target value of the contract; and the at least one processor to store data comprises at least one processor to:

store data indicative of the target savings in the data object defining the contract with the supplier.

This summary is not intended to be exhaustive and/or limiting. For example, while some aspects are described in this summary, other aspects may not be described in this summary but rather may be apparent from the description, drawings and/or claims which follow. In addition, for example, nor is each portion of each aspect in this summary, and/or any possible advantages thereof, required in every aspect.

### BRIEF DESCRIPTION OF THE DRAWINGS

FIG. 1 is a block diagram of a system according to some embodiments.

FIGS. 2A-2D are a flow chart of a method, in accordance with some embodiments.

FIG. 3 is a representation of a view in a graphical user interface provided by a simulation tool, in accordance with some embodiments.

FIG. 4 is a representation of a view in a graphical user interface provided by a simulation tool, in accordance with some embodiments.

FIG. 5 is a flow chart of a method, in accordance with some embodiments.

FIG. 6 is a representation of a view in a graphical user interface showing a portion of a contract, in accordance with some embodiments.

FIG. 7 is a representation of a view in a graphical user interface showing a portion of a contract, in accordance with some embodiments.

FIG. 8 is a representation of a view in a graphical user interface showing a portion of a contract, in accordance with some embodiments.

FIG. 9 is a representation of a view in a graphical user interface showing a portion of a contract, in accordance with some embodiments.

FIG. 10 is a representation of a view in a graphical user interface showing a portion of a contract, in accordance with some embodiments.

FIG. 11 is a representation of a view in a graphical user interface showing a portion of a contract, in accordance with some embodiments.

FIG. 12 is a representation of a view in a graphical user interface showing a portion of a report, in accordance with some embodiments.

FIG. 13 is a block diagram of an architecture, in accordance with some embodiments.

### DETAILED DESCRIPTION

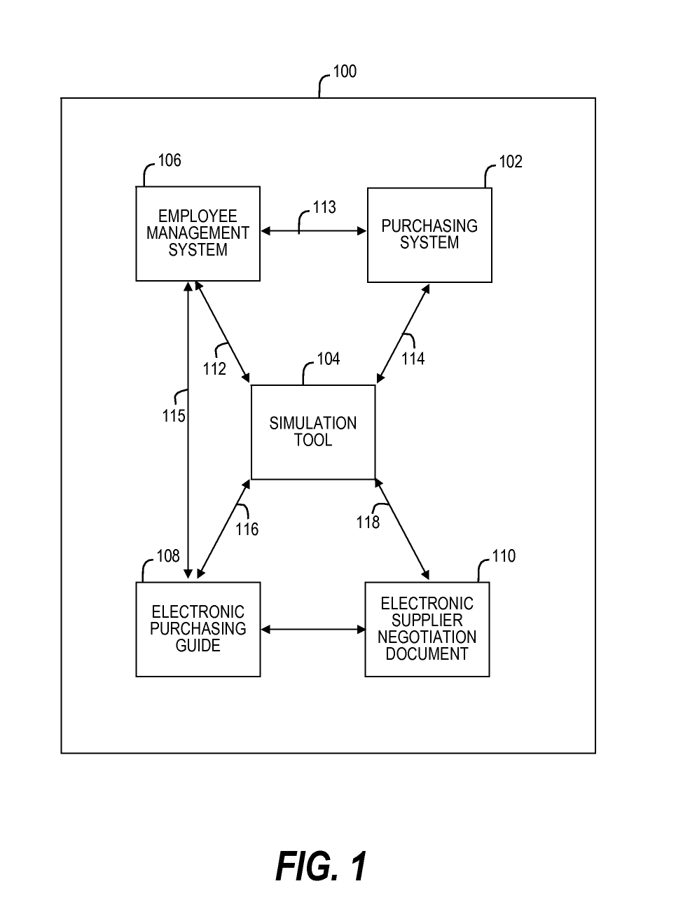

FIG. 1 is a block diagram of a system 100 in accordance with some embodiments.

Referring to FIG. 1, in accordance with some embodiments, the system 100 includes a purchasing system 102, a simulation tool 104, an employee management system 106, an electronic purchasing guide 108, and an electronic supplier negotiation document 110. The system 100 may further include communication links 112-118 that couple the purchasing system 102, the simulation tool 104, the employee management system 106, the electronic purchasing guide 108 and the electronic supplier negotiation document 110.

The purchasing system 102 may provide functions related to the creation, tracking and/or storage of contracts and/or purchase orders. In some embodiments, the purchasing system stores data objects that define the contracts and/or purchase orders and/or are otherwise indicative of purchasing activities. In some embodiments, the purchasing system 102 comprises a supplier relationship management (SRM) system and/or an enterprise resource planning (ERP), such as for example, an SRM and/or ERP provided by SAP AG™ headquartered in Walldorf, Germany.

The simulation tool 104 may be used to explore the possibility of savings in purchasing activities. As further described below, in some embodiments, the simulation tool provides multiple views and a capability for drill down to obtain information for an individual product. The drill down information may include information regarding individual suppliers of the product, quantities of the product that may be procured from the individual suppliers, and/or prices associated with procurement of the product from the individual suppliers. The simulation tool may also allow a user to propose changes to purchasing activities, to request determination (e.g., by simulation) of a result of the changes and/or to request that the result be stored.

The employee management system 106 may provide functions relating to the management and/or evaluation of employees. In some embodiments, the employee management system 106 stores data objects indicative of employee objectives (e.g., key performance indicators (KPIs) and/or bonus agreements and assists in the evaluation of employees based at least in part on the employee objectives and the results of employer and/or employee activities. In some embodiments, the employee management system 106 comprises a human capital management (HCM) system, such as for example, an HCM system provided by SAP AG™ headquartered in Walldorf, Germany.

The electronic purchasing guide 108 may include performance objectives for an entity and/or employees involved in purchasing activities. In some embodiments, the electronic purchasing guide comprises an electronic purchasing guide provided by SAP AG™ headquartered in Walldorf, Germany.

The electronic supplier negotiation document 110 may store data that may be used by employees in the course of negotiation with one or more suppliers. In some embodiments, an electronic supplier negotiation document is customized for a particular supplier and includes information that may be helpful in negotiations with, and/or auditing of, the particular supplier. In some embodiments, the electronic supplier negotiation document may include: basic data regarding the supplier, contract data, a supplier evaluation score, spending with the supplier (i.e., monetary amount(s) paid to the supplier) and/or possible savings (e.g., per product category with drill down to specific products).

In some embodiments, one or more portions of the system 100 may be the same as and/or similar to one or more portions of one or more systems disclosed in US Application Publication No US2009/0171770, based on an application filed on Dec. 31, 2007, the entirety of which is incorporated herein by reference.

In some embodiments, the purchasing system 102, the simulation tool 104, the employee management system 106, the electronic purchasing guide 108 and the electronic supplier negotiation document 110 are all embodied in a single processing system within system 100.

In some other embodiments, one or more of the purchasing system 102, the simulation tool 104, the employee management system 106, the electronic purchasing guide 108 and the electronic supplier negotiation document 110 are embodied in separate processing systems within system 100.

In some embodiments, the simulation tool 104 is embodied in a mobile user device. In some embodiments, a mobile user device comprises a smart phone and/or other type of smart, hand held mobile user device. In some embodiments, a smart hand held mobile user device comprises an IPAD™ or IPOD™ manufactured by APPLE™.

As stated above, from time to time, it may be desirable to explore the potential for savings in purchasing activities. However, it may also be desirable to achieve actual savings rather than merely identify potential savings.

To this effect, it has been determined that It would be helpful to store data that identifies potential savings in association with data indicative of the purchasing activities.

It has also been determined that it would be helpful to evaluate and reward employees on the basis of whether the potential savings are actually achieved.

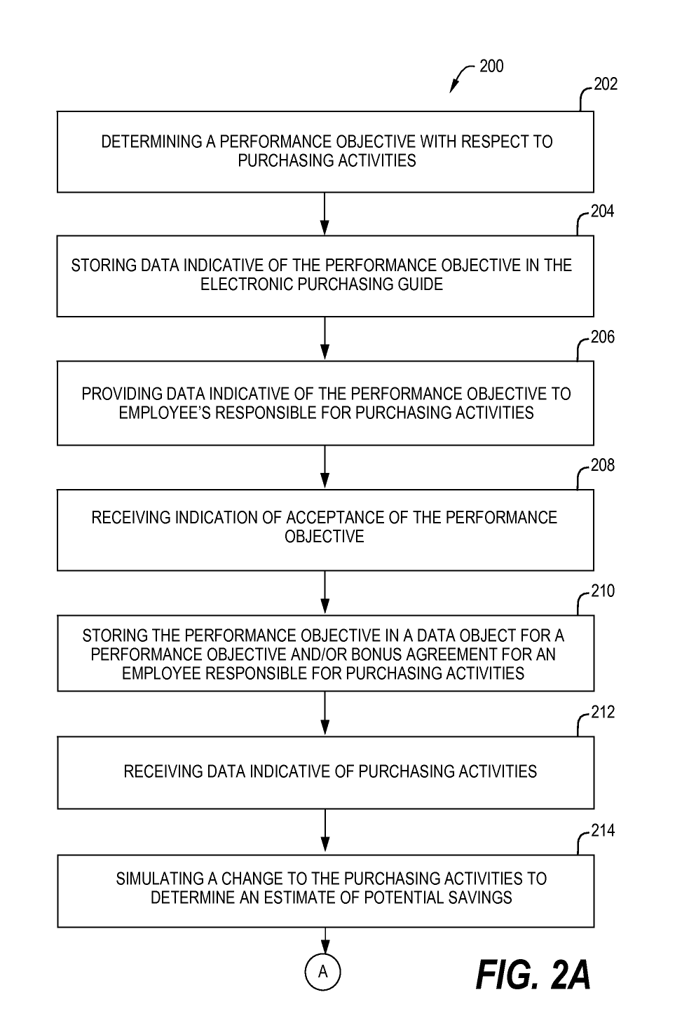

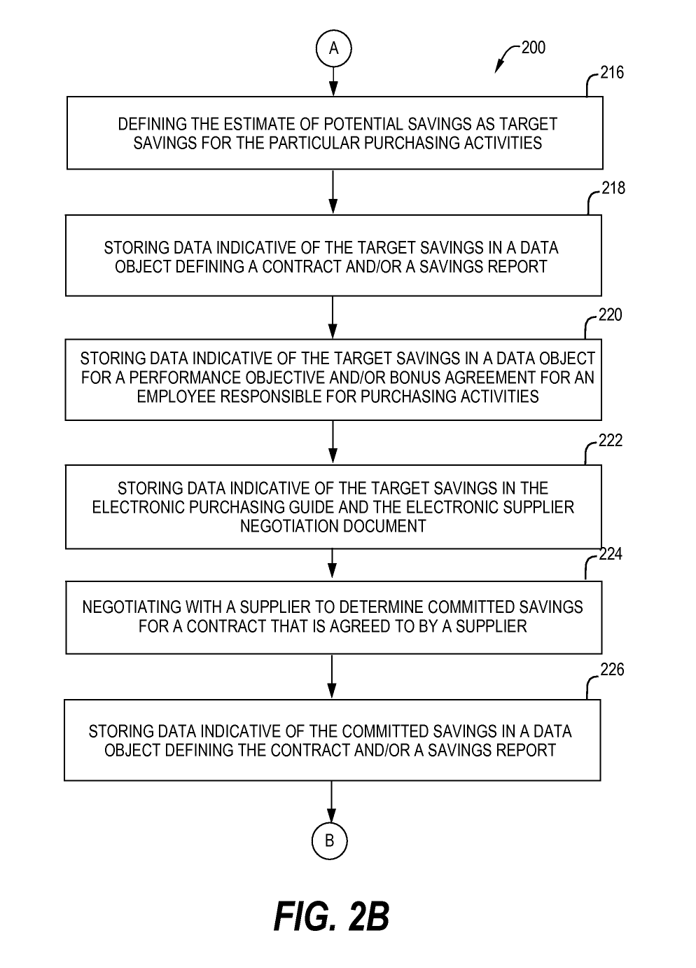

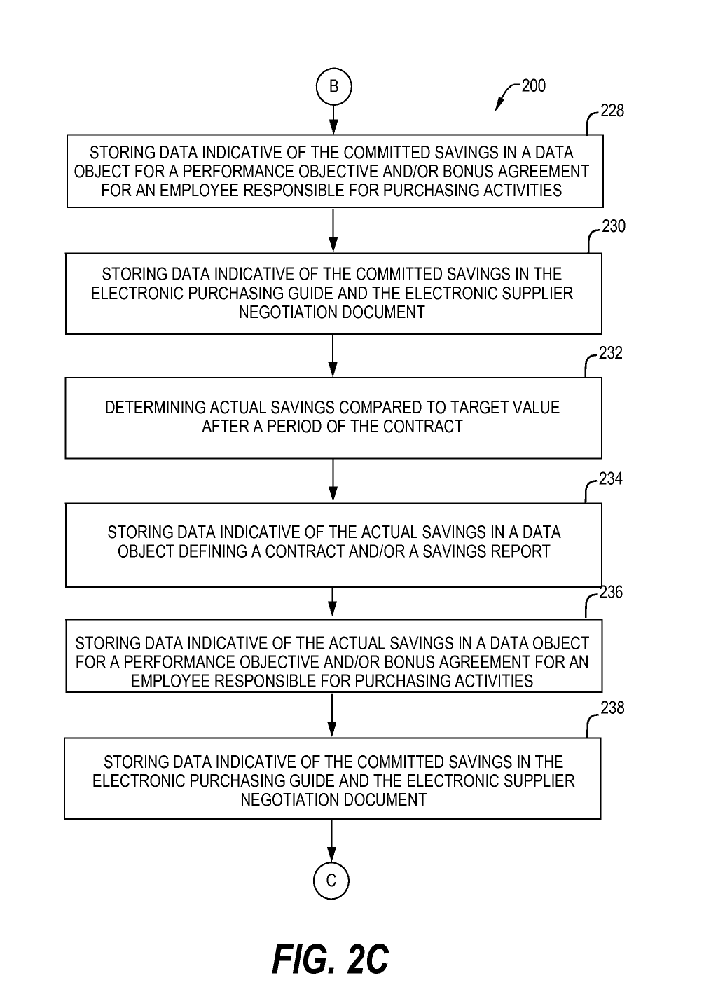

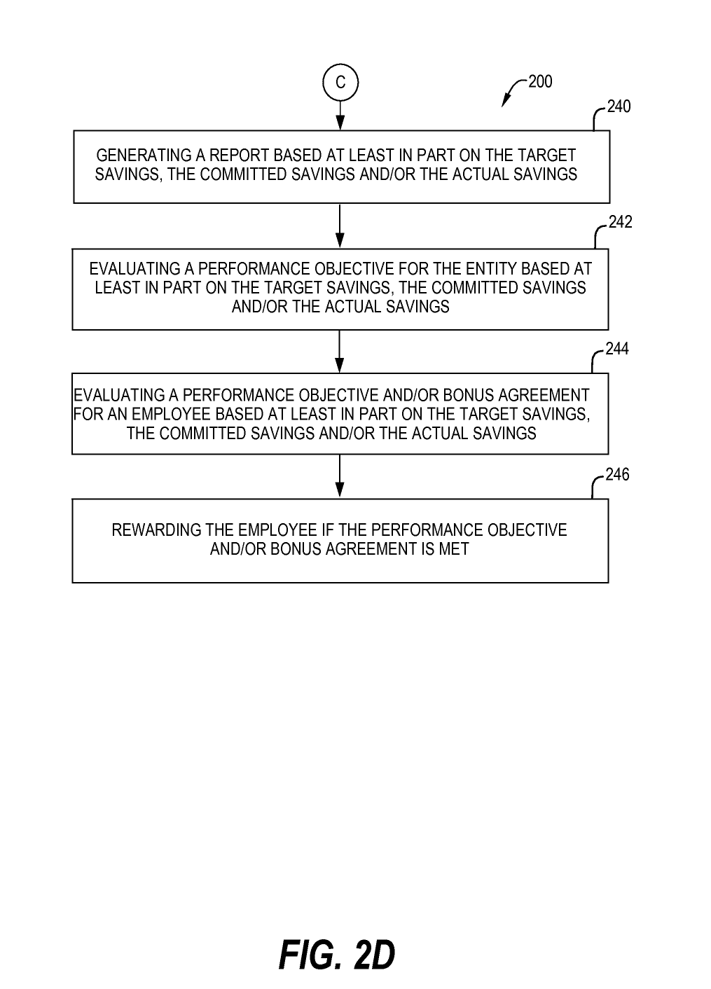

FIGS. 2A-2D are a flow chart 200 of a method according to some embodiments. The method and all other methods described herein may be performed using hardware, software (including low level language code), or any combination thereof. In some embodiments, the method and all other methods described herein may be performed by the system 100.

In some embodiments, a storage medium may store thereon instructions that when executed by a machine result in performance of the method and/or any other method herein. In some embodiments, the storage medium may comprise a floppy disk, a CD-ROM, a DVD-ROM, a Zip™ disk, or a magnetic tape.

In alternative embodiments, hard-wired circuitry may be used in place of, or in combination with, processor-executable program code for implementation of processes according to some embodiments. Thus, embodiments are not limited to any specific combination of hardware and software.

The method is not limited to the order shown in the flow chart. Rather, embodiments of the method, and any method disclosed herein, may be performed in any order that is practicable. Moreover, some embodiments may employ one or more portions of a method without one or more other portions of a method.

Referring to FIGS. 2A-2D, at 202, the method may include determining a performance objective with respect to purchasing activities.

In some embodiments, the performance objective comprises a savings goal set by a manager (e.g., a head of a purchasing organization) with respect to purchasing activities for an entity. For example, the manager may determine that the performance objective is to save an amount equal to 10% of the prior year's purchasing volume.

In some embodiments, the manager determines the performance objective by analyzing spending on a basis of product categories (e.g., the 10 product categories responsible for the highest amounts of spending), and/or on the basis of products (e.g., the 10 products responsible for the highest amounts of spending).

At 204, the method may further include storing data indicative of the performance objective in an electronic purchasing guide for use by employees involved in purchasing activities.

At 206, the method may further include providing data indicative of the performance objective to employees responsible for purchasing activities.

If the employee is responsible for the purchasing of a particular product or product category related to the performance objective, the employee may be responsible for achieving the (performance objective (e.g., the savings goal) with respect to the purchase of that particular product or product category.

In some embodiments, each such employee must indicate acceptance of the performance objective (e.g., the savings goal defined by the manager) in order for the performance objective to apply to the employee. In some embodiments, this may be done via the electronic purchasing guide.

At 208, the method may further include receiving one or more indications of acceptance of the performance objective.

At 210, the method may further include storing data indicative of the performance objective in a data object for a performance objective and/or bonus agreement for an employee responsible for purchasing activities.

In some embodiments, the performance objective and/or bonus agreement for the employee comprises a performance objective and/or bonus agreement that is stored in the employee management system 106.

At 212, the method may further include receiving data indicative of purchasing activities. In some embodiments, the purchasing activities may comprise current purchasing activities, previous purchasing activities, future purchasing activities, planned purchasing activities, potential purchasing activities and/or any other type of purchasing activities.

In some embodiments, the data comprises data objects that define contracts with suppliers, purchase orders and/or one or more summaries of one or more such contracts and/or purchase orders. In some embodiments, a data object for a contract defines a target value, a target quantity and/or a target price for particular purchasing activities. In some embodiments, a data object comprises an Excel spreadsheet.

At 214, the method may further include simulating a change to the purchasing activities to determine an estimate of potential savings for particular purchasing activities. In some embodiments, the change may represent a price change and/or a shifting of some or all purchasing volume from one supplier to another supplier.

In some embodiments, the simulation may be performed by an employee using the simulation tool 104.

At 216, the method may further include defining the estimate of potential savings as target savings for the particular purchasing activities.

At 218, the method may further include storing data indicative of the target savings in a data object defining a contract and/or a savings report. In some embodiments, the data may be in terms of absolute (monetary) amounts and/or percentages. The contract may comprise a contract that would be affected if the simulated change was to be made.

At 220, the method may further include storing data indicative of the target savings in a data object for a performance objective and/or bonus agreement for an employee responsible for purchasing activities associated with the performance objective.

In some embodiments, the target savings are treated as a performance objective for the employee.

In some embodiments, the performance objective and/or bonus agreement for the employee are stored in the employee management system 106.

At 222, the method may further include storing data indicative of the target savings in the electronic purchasing guide and the electronic supplier negotiation document.

As stated above, in some embodiments, the change may represent a price change and/or a shifting of some or all purchasing volume from one supplier to another supplier.

Consequently, at 224, the method may further include negotiating with a supplier to determine a committed savings for a contract (e.g., compared to a target value of the contract) that is agreed to by a supplier.

At 226, the method may further include storing data indicative of the committed savings in a data object defining the contract with the supplier and/or in a savings report. In some embodiments, the data may be in terms of absolute (monetary) amounts and/or percentages.

In some embodiments, purchase orders generated after the supplier agrees to the committed savings may use data that reflects the committed savings (e.g., a lower price agreed to by the supplier).

At 228, the method may further include storing data indicative of the committed savings in a data object for a performance objective and/or bonus agreement for an employee responsible for purchasing activities.

At 230, the method may further include storing data indicative of the committed savings in the electronic purchasing guide and the electronic supplier negotiation document.

At 232, the method may further include determining actual savings compared to the target value of the contract, over a period of the contract. In some embodiments, the determined actual savings may be the actual savings and/or an estimate of actual savings.

In some embodiments, the actual savings may be based on purchase order amounts and/or actual savings based on supplier invoice amounts.

In some embodiments, the actual savings may be less than the committed savings if the invoice price for a product did not match the purchase order price for the product.

At 234, the method may further include storing data indicative of the actual savings in a data object defining the contract with the supplier and/or in a savings report.

At 236, the method may further include storing data indicative of the actual savings in a data object indicative of a performance objective and/or bonus agreement for an employee responsible for purchasing activities.

At 238, the method may further include storing data indicative of the actual savings in the electronic purchasing guide and the electronic supplier negotiation document.

At 240, the method may further include generating a report summarizing target savings, committed savings and/or actual savings for the entity.

In some embodiments, reports are generated periodically and provided to the manager and/or each employee associated with the information in the report.

In some embodiments, the reports indicate and/or match the following: the performance objective (e.g., the savings goals and/or targeted savings defined by the manager), the relationship of the performance objective to salary of an employee (e.g., key performance indicators (KPI's) defined in an individual employee's performance feedback meeting).

At 242, the method may further comprise evaluating a performance objective of the entity based at least in part on at least one of the target savings, the committed savings and/or the actual savings

At 244, the method may further comprise evaluating a performance objective and/or bonus agreement of an employee based at least in part on at least one of the target savings, the committed savings and/or the actual savings.

In some embodiments, the employee is the employee that performed the simulation and/or requested storing of the results.

At 246, the method may further comprise rewarding the employee if the performance objective and/or bonus agreement is met.

In some embodiments, the results may be used for deriving the performance objective (e.g., targeted savings) for the next year.

As stated above, in some embodiments, the simulation tool 104 may be used in performing a simulation.

As stated above and as further described below, in some embodiments, the simulation tool provides multiple views and a capability for drill down to obtain information for an individual product. The drill down information may include information regarding individual suppliers of the product, quantities of the product that may be procured from the individual suppliers, and/or prices associated with procurement of the product from the individual suppliers. The simulation tool may also allow a user to propose changes to purchasing activities, to request determination (e.g., by simulation) of a result of the changes and/or to request that the result be stored.

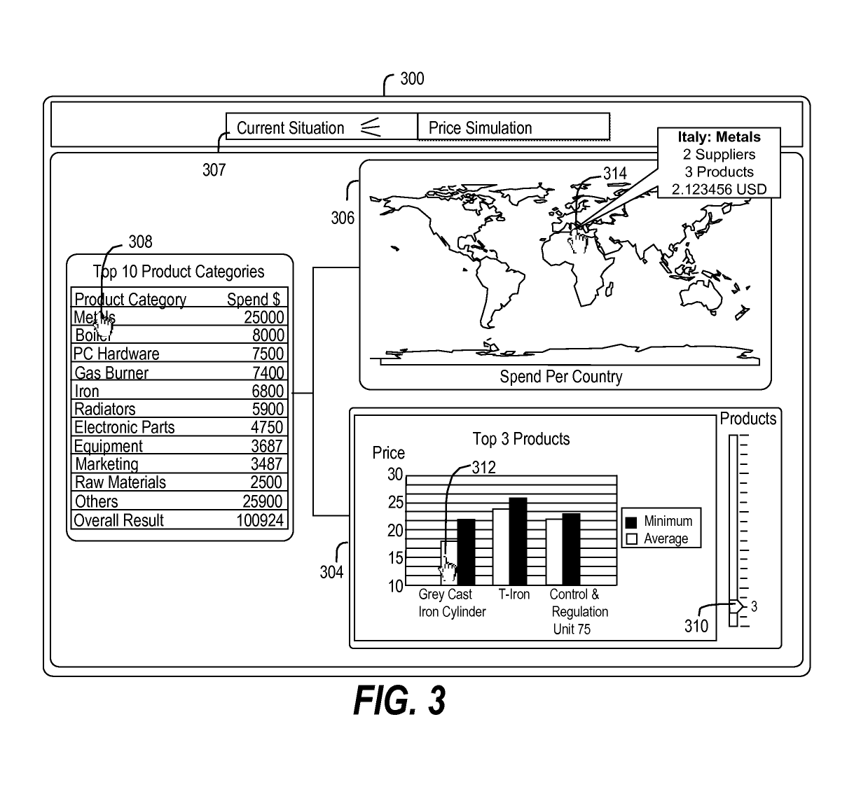

FIG. 3 is a representation of a view 300 in a graphical user interface that may be provided by a simulation tool, i.e., a device that serves at least in part as a simulation tool. In some embodiments, the simulation tool may be used in performing the simulation and/or one or more other portions of the method 200.

Referring to FIG. 3, the view 300 includes three information areas 302-306 that may provide information regarding a current situation (as indicated by indicator 307). The first information area 302 (which may have the form of a table) lists ten product categories that are responsible for the highest amounts of spending (e.g., overall procurement cost). The list may be sorted based on the amount of spending for each product category. For example, the first product category in the list (e.g., Metals) is responsible for a highest amount of spending (e.g., $25,000). A second product category in the list (e.g., Boiler) is responsible for a second highest amount of spending (e.g., $8,000). And so on.

Product categories that are not responsible for one of the ten highest amounts may be summarized by an additional entry (e.g., Other). The spending for such product categories may be summarized by the spending amount (e.g., $100,924) associated with such entry.

The first area 302 may include a graphical tool 308 that may be used in selecting one of the product categories for which more information is desired. In some embodiments, the graphical tool 308 comprises a movable selection tool (e.g., a pointer) that may be positioned (e.g., by moving a mouse) and activated (e.g., by depressing a button on the mouse) to indicate a selection. The graphical editing tool 308 is shown selecting the first product category in the list (e.g., Metals).

The second information area 304 (which may have the form of a bar chart) provides additional information regarding products (e.g., Grey Cast Iron Cylinder, T-Iron and Control & Regulation Unit 75) in the selected product category that are responsible for the highest amounts of spending (e.g., overall procurement cost) within such product category. In some embodiments, the second area includes an average price and/or a minimum price for each of such products over a particular time period (e.g., three months).

The number of products for which additional information is provided may be adjustable. In some embodiments, the number is adjusted by using a graphical tool 310. In some embodiments, the graphical tool 310 comprises a slider bar that may be moved (e.g., by using a mouse) to a position that indicates a number of products for which additional information is to be provided in the second area 304. The graphical editing tool 310 is shown in a position (e.g., 3) indicating that information is to be provided for three products.

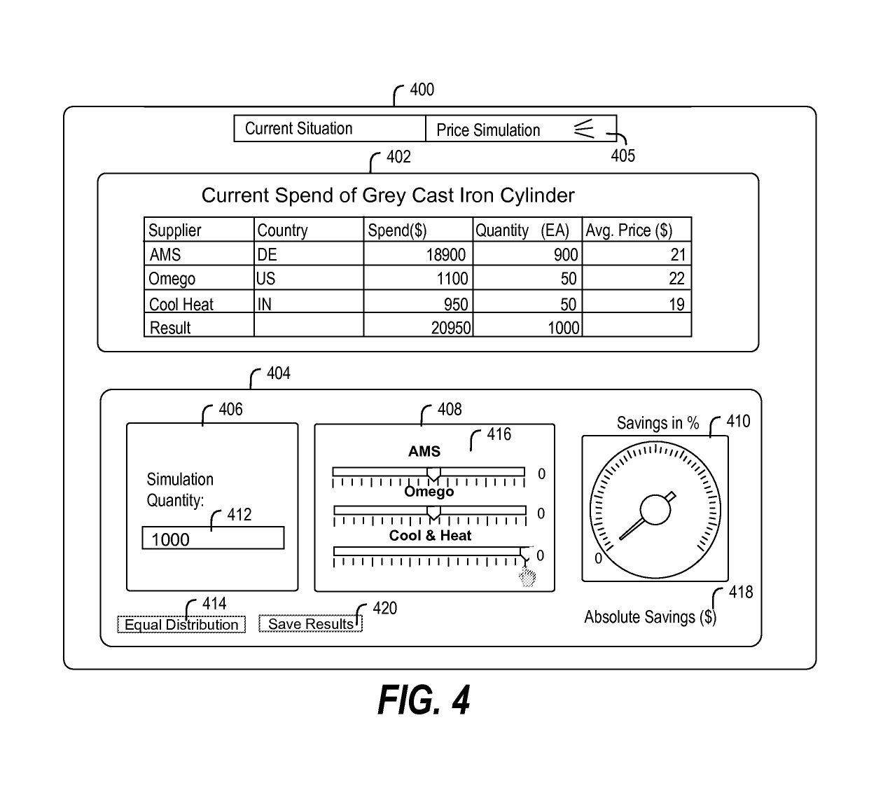

The second area 304 may further include a graphical tool 312 that may be used in selecting one of the products for which more information is desired. In some embodiments, the graphical tool 312 comprises a movable selection tool (e.g., a pointer) that may be positioned (e.g., by moving a mouse) and activated (e.g., by depressing a button on the mouse) to indicate a selection. The graphical editing tool 312 is shown selecting the first product in the chart (e.g., Grey Cast Iron Cylinder). The additional information that may provided by selecting one of the products (e.g., Grey Cast Iron Cylinder) is further described below with respect to FIG. 4.

The third information area 306 (which may have the form of a map) provides additional information regarding the selected product category. In particular, the third area 306 provides information indicating the number of suppliers (e.g., 2), the number of products (i.e., 3) and the amount of spending (e.g., $2.123456) that is associated with the selected product category in a country of interest (e.g., Italy).

The third area 306 may include a graphical tool 314 that may be used in selecting the particular country of interest. In some embodiments, the graphical tool 314 comprises a movable selection tool (e.g., a pointer) that may be positioned (e.g., by moving a mouse) and activated (e.g., by depressing a button on the mouse) to indicate a selection. The graphical editing tool 314 is shown selecting the Italy as the country of interest.

FIG. 4 is a representation of a view 400 in a graphical user interface that may be provided by the simulation tool after selection of one of the products (e.g., Grey Cast Iron Cylinder) in the second area 304 of view 300 in FIG. 3.

Referring to FIG. 4, the view 400 includes two information areas 402-404 that may provide information for a price simulation (as indicated by indicator 405). The first information area 402 (which may have the form of a table) lists current suppliers of the selected one of the products (e.g., Grey Cast Iron Cylinder). The table may also list the location (Country) of each supplier, the quantity of the selected product that is procured from each supplier (Quantity), the amount spent (Spend$) procuring the quantity of the selected product from each supplier and the average price (Avg. Price) paid to each supplier for a quantity of one of the selected product, over a period of time.

The second information area 404 may include three regions 406-410. A first region 406 may indicate a desired simulation quantity (e.g., 1000). In some embodiments, the simulation quantity may automatically default to the previous years procured quantity (e.g., 1000).

The first region 406 may include a graphical tool 412 to change the simulation quantity. In some embodiments, the graphical tool 412 comprises a typing box to allow a desired simulation quantity to be entered by manual typing on a keyboard. The graphical editing tool 412 is shown indicating a simulation quantity of 1000.

A second region 408 may indicate a desired allocation of the simulation quantity (e.g., 1000) among the suppliers of the selected product. Thus, the graphical user interface provides information for analysis of potential savings that may be achieved by changing an allocation of purchasing volume (e.g., a quantity of products to be purchased) among possible suppliers (i.e., changing the quantity to be purchased from some or all of the suppliers).

In some embodiments, the allocation may automatically default to the previous years allocation and/or an equal allocation of the simulation quantity among the suppliers.

In some embodiments, a graphical tool 414 (e.g., a button) may be activated or otherwise used to select an equal allocation of the simulation quantity among the suppliers.

The second region 406 may include a graphical tool 416 to change the allocation. In some embodiments, the graphical tool 416 comprises a plurality of slider bars that may be moved (e.g., by using a mouse) to positions that indicate a desired allocation. The graphical editing tool 416 is shown in a position (e.g., 3) indicating that the entire simulation quantity is to be split equally between two of the suppliers.

The third region 410 (which may have the form of an indicator, e.g. a speedometer) provides information regarding the potential savings from the allocation indicated in the second region 408. In some embodiments, the information indicates the potential savings as a percentage compared to the current situation. The indicator is shown indicating that there would be no potential savings from the allocation in the second region 408. In some embodiments, another indicator, e.g., 418, is also provided. One of the indicators, e.g., 410, may indicate the potential savings as a percentage. The other indicator, e.g., 418, may indicate the potential savings as a monetary amount.

In some embodiments, a graphical tool 420 (e.g., a button) may be activated or otherwise used to request that data indicative of one or more result of the simulation be saved (i.e., stored). In some embodiments, the one or more result comprises the potential savings from the simulation.

The one or more result may be stored in association with data indicative of the purchasing activities. In some embodiments, the potential savings from the simulation is stored as target savings in association with data indicative of the purchasing activities.

In some embodiments, the one or more result of the simulation is stored in a data object defining a contract (with a supplier) that would be affected by the simulated change if the simulated change was to be put into effect. In some embodiments, the data indicative of a result of the simulation is stored in a savings report.

In some embodiments, the target savings are also stored in at least one of an electronic purchasing guide, an electronic supplier negotiation document and a human capital management system.

In some embodiments, the graphical user interface of the simulation tool provides information for analysis of influence of a plurality of factors that may include factors in addition to those shown in FIG. 4. In some embodiments, these factors may include price (including any surcharges and rebates), delivery costs, shipping conditions, payment terms (e.g., cash discount) and/or incoterms (i.e., free on board).

In some embodiments, the information provided by the simulation tool comprises information for product categories having a highest amount of spending for the last three years, quantities procured for the last three years, prices and conditions for the last three years and the influence of currency exchange rates for the last three years (if applicable).

In some embodiments, one or more portions of the information may be supplied by and/or stored to an ERP system, an Excel™ spreadsheet, an electronic purchasing guide and/or an HCM system.

In some embodiments, data for the analysis and/or simulation is supplied by purchase orders, contracts, and/or spending reports (e.g., based on analytics or an ERP system (e.g., spending based on invoice values). In some embodiments, data for the analysis and/or simulation is from contracts and/or purchase orders that include data indicative of one, some or all of the following: price, quantity, net value (e.g., spending based on purchase order values), payment terms, delivery conditions and/or incoterms

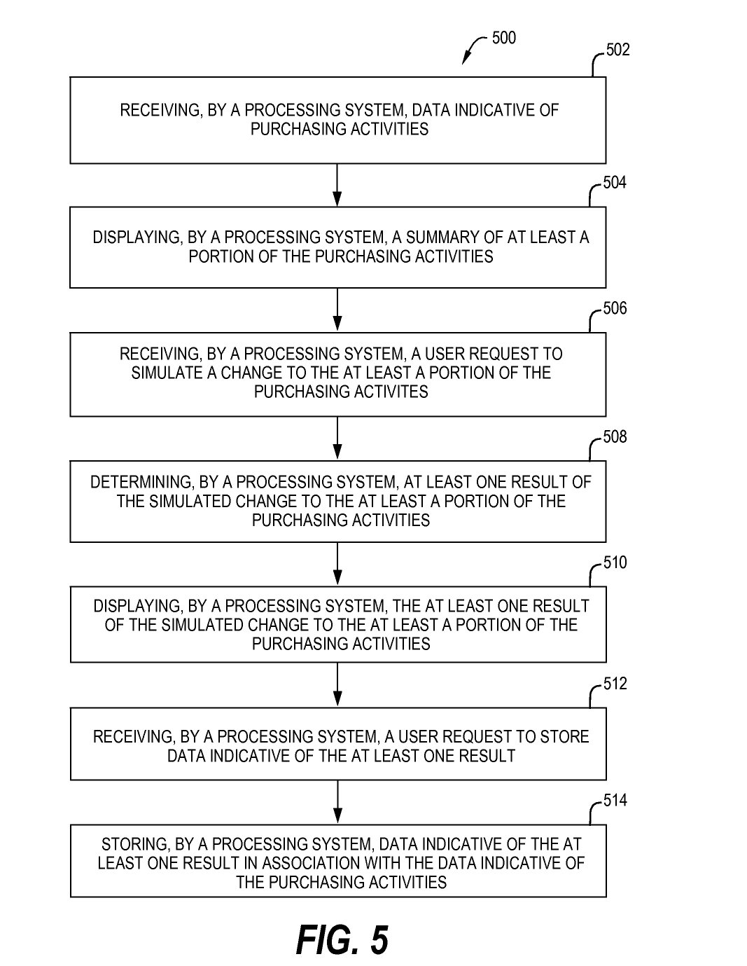

FIG. 5 is a flow chart 500 of a method according to some embodiments. In some embodiments, one or more portions of the method may be performed by one or more of the processing systems in the system 100.

Referring to FIG. 5, 502, the method may include receiving, by a processing system, data indicative of purchasing activities.

At 504, the method may further include displaying, by a processing system, a summary of at least a portion of the purchasing activities.

At 506, the method may further include receiving, by a processing system, a user request to simulate a change to the at least a portion of the purchasing activities.

At 508, the method may further include determining, by a processing system, at least one result of the simulated change to the at least a portion of the purchasing activities.

At 510, the method may further include displaying, by a processing system, the at least one result of the simulated change to the at least a portion of the purchasing activities.

At 512, the method may further include receiving, by a processing system, a user request to store data indicative of the at least one result.

At 514, the method may further include storing, by a processing system, data indicative of the at least one result in association with the data indicative of the purchasing activities.

In some embodiments, the at least one result comprises: an estimate of potential savings from the simulated change to the at least a portion of the purchasing activities; and the storing comprises: storing data indicative of the estimate of potential savings in association with the data indicative of the purchasing activities.

In some embodiments, the data indicative of purchasing activities comprises a data object defining a contract with a supplier; and the storing comprises: storing the data indicative of the at least one result in the data object defining the contract with a supplier.

In some embodiments, the contract with the supplier comprises a target value for the contract, the at least one result of the simulated change defines a target savings for the contract compared to the target value of the contract; and the storing comprises: storing data indicative of the target savings in the data object defining the contract with the supplier.

In some embodiments, the method further comprises: receiving data indicative of committed savings, compared to the target value of the contract, that are agreed to by the supplier; and storing the data indicative of the amount savings that is agreed to by the supplier in the data object defining the contract with the supplier.

In some embodiments, the method further comprises receiving data indicative of actual savings over a period of the contract compared to the target value of the contract; and storing the data indicative of the actual amount saved in the data object defining the contract with the supplier.

In some embodiments, the method further comprises generating an evaluation based at least in part at least one of the target savings, the committed savings and the actual savings.

In some embodiments, the method further comprises storing at least one of the target savings, the committed savings and the actual savings in at least one of an electronic purchasing guide, an electronic supplier negotiation document and a human capital management system.

In some embodiments, the displaying a summary of at least a portion of the purchasing activities comprises: displaying a plurality of product categories and a plurality of monetary amounts, each of the plurality of monetary amounts being associated with a respective one of the plurality of product categories.

In some embodiments, the method further comprises determining the plurality of product categories and the plurality of amounts based at least in part on the data indicative of the purchasing activities.

In some embodiments, the method further comprises: receiving, by a processing system, user input indicative of a selected one of the plurality of product categories; wherein the displaying a summary of at least a portion of the purchasing activities comprises: displaying a description of at least one product that is within the selected product category; and displaying at least one monetary amount that is associated with the at least one product and based at least in part on the data indicative of the purchasing activities.

In some embodiments, the method further comprises: receiving, by a processing system, user input indicative of a selected one of the at least one product; determining a plurality of suppliers of the selected product based at least in part on the data indicative of the purchasing activities; determining a plurality of quantities based at least in part on the data indicative of the purchasing activities, each of the plurality of quantities being associated with a respective one of the plurality of suppliers and being indicative of a quantity of the selected product that is to be procured from the associated supplier; determining a plurality of prices based at least in part on the data indicative of the purchasing activities, each of the plurality of prices being associated with a respective one of the plurality of suppliers and being indicative of at least one price charged by the associated supplier for the selected product.

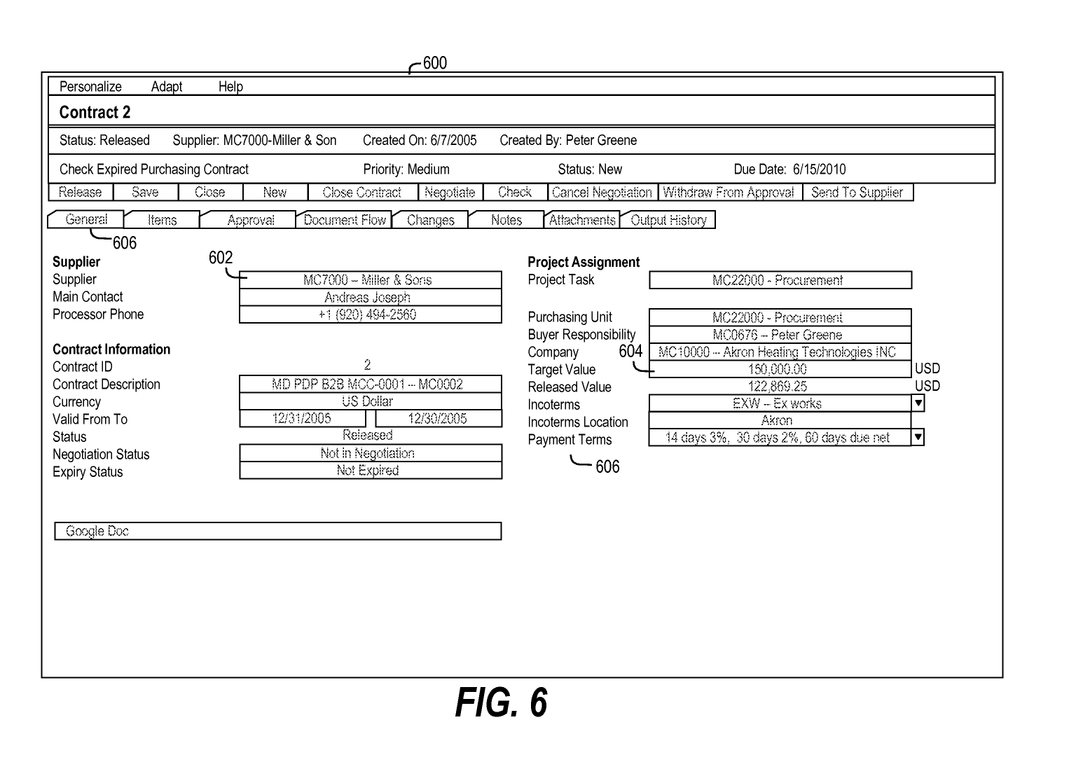

FIG. 6 is a representation of a view 600 in a graphical user interface showing a portion of a contract prior to storing result(s) of a simulation (e.g., target savings) in the contract, in accordance with some embodiments.

Referring to FIG. 6, in accordance with some embodiments, the contract may define a supplier 602 and a target value 604. The contract may also include data defining other terms, e.g., incoterms 606.

In some embodiments, the view 600 is requested by activating a graphical tool 606 (e.g., shown as a tab labeled general).

As can be seen, there is no result(s) of the simulation.

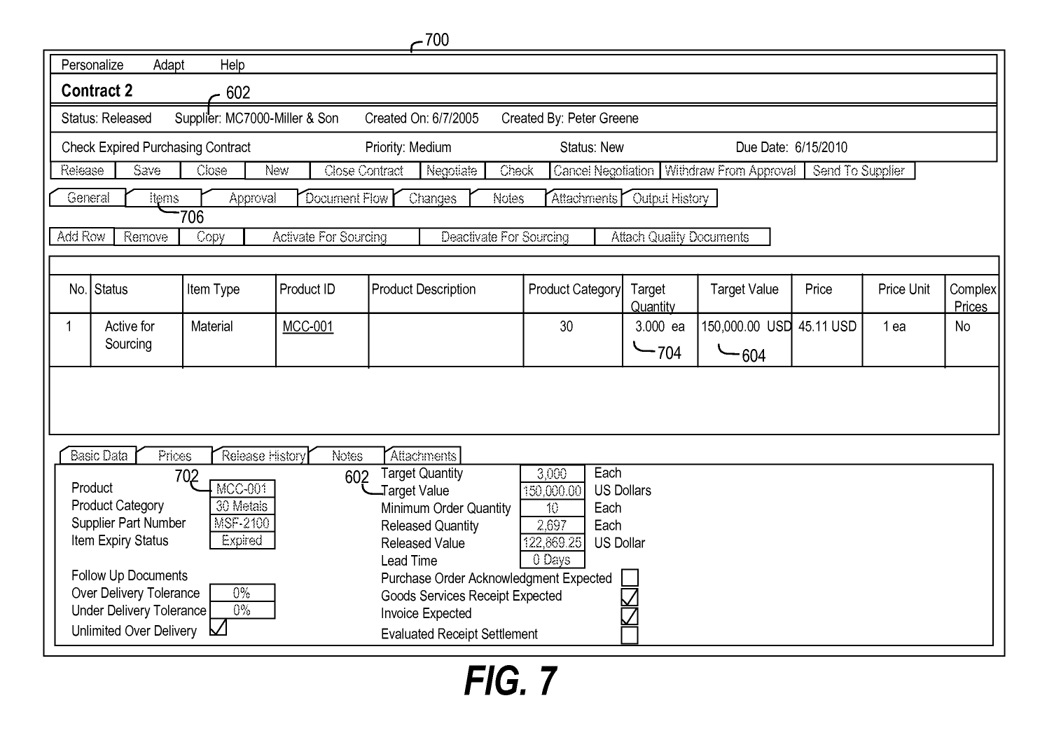

FIG. 7 is a representation of a view 700 in a graphical user interface showing another portion of the contract with the supplier prior to addition of result(s) of the simulation, in accordance with some embodiments.

Referring to FIG. 7, in accordance with some embodiments, the contract may further define a product 702 and a target quantity 704.

In some embodiments, the view 700 is requested by activating a graphical tool 706 (e.g., shown as a tab labeled item).

As can be seen, there is no result(s) of the simulation.

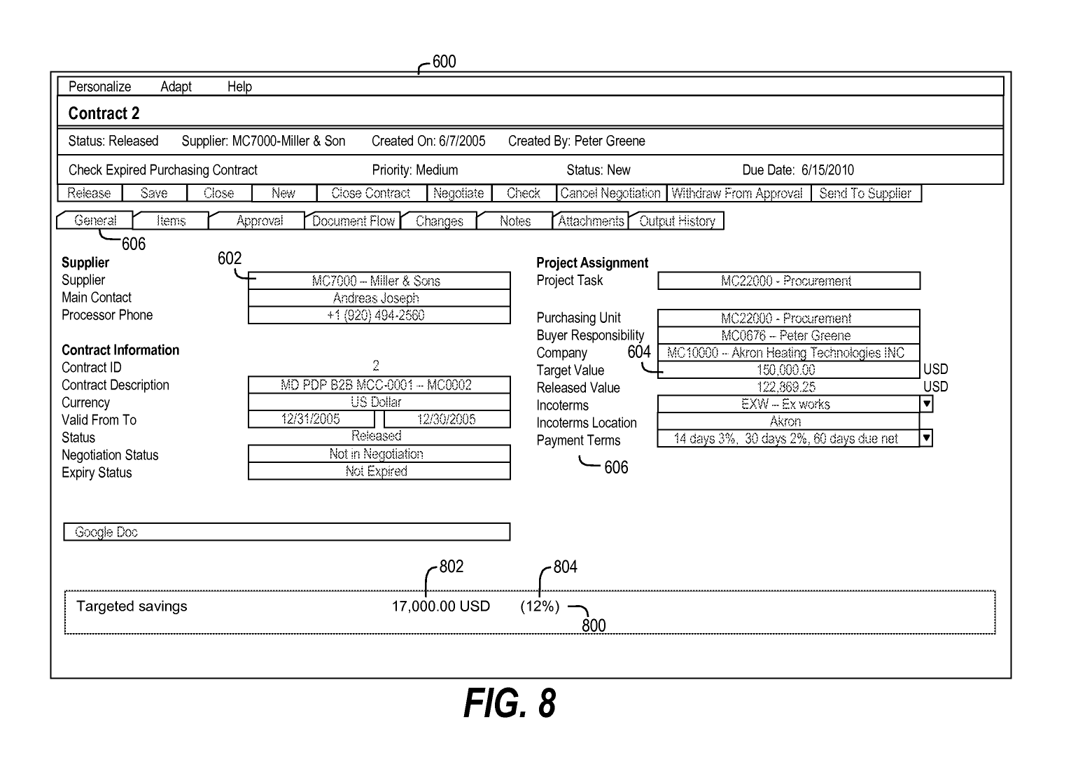

FIG. 8 is a representation of the view 500 in the graphical user interface after storing result(s) of the simulation (e.g., target savings) in the contract, in accordance with some embodiments.

Referring to FIG. 8, in accordance with some embodiments, the contract now also includes a target savings 800.

In some embodiments, the target savings are indicated as a monetary amount 802 and/or as a percentage 804 (e.g., compared to the target value 604).

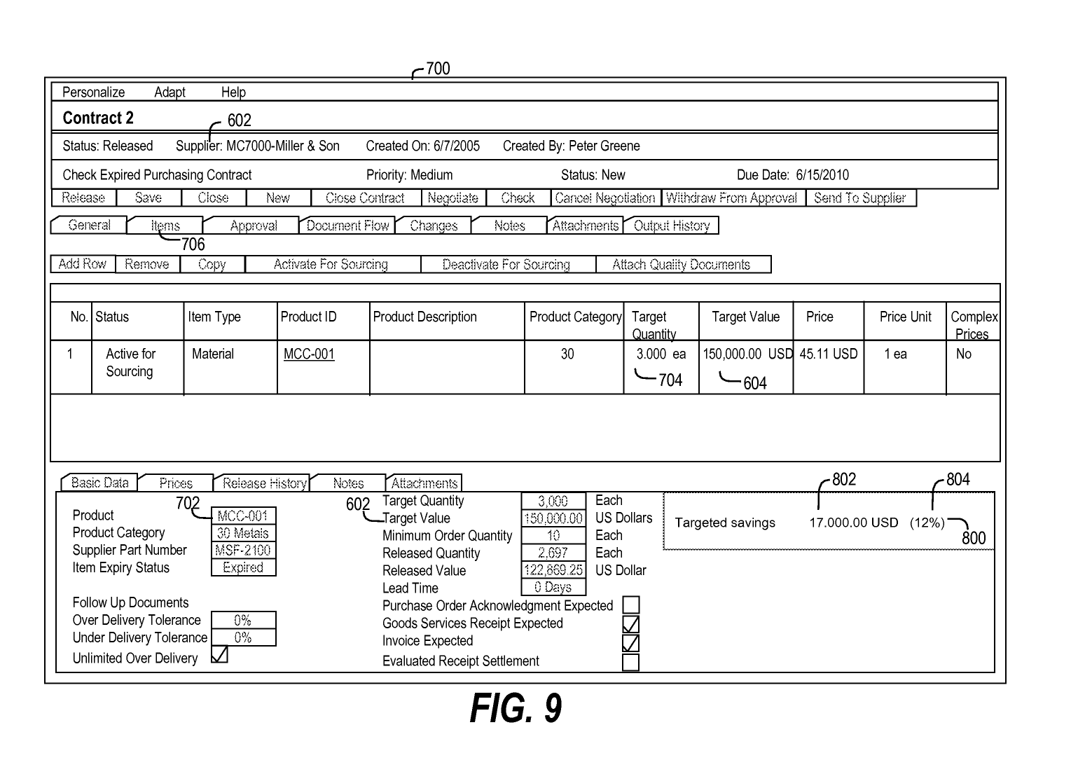

FIG. 9 is a representation of the view 600 in the graphical user interface after storing result(s) of the simulation (e.g., target savings) in the contract, in accordance with some embodiments.

Referring to FIG. 9, in accordance with some embodiments, the contract now also includes the target savings 800.

In some embodiments, the target savings are indicated as a monetary amount 802 and/or as a percentage 804 (e.g., compared to the target value 604).

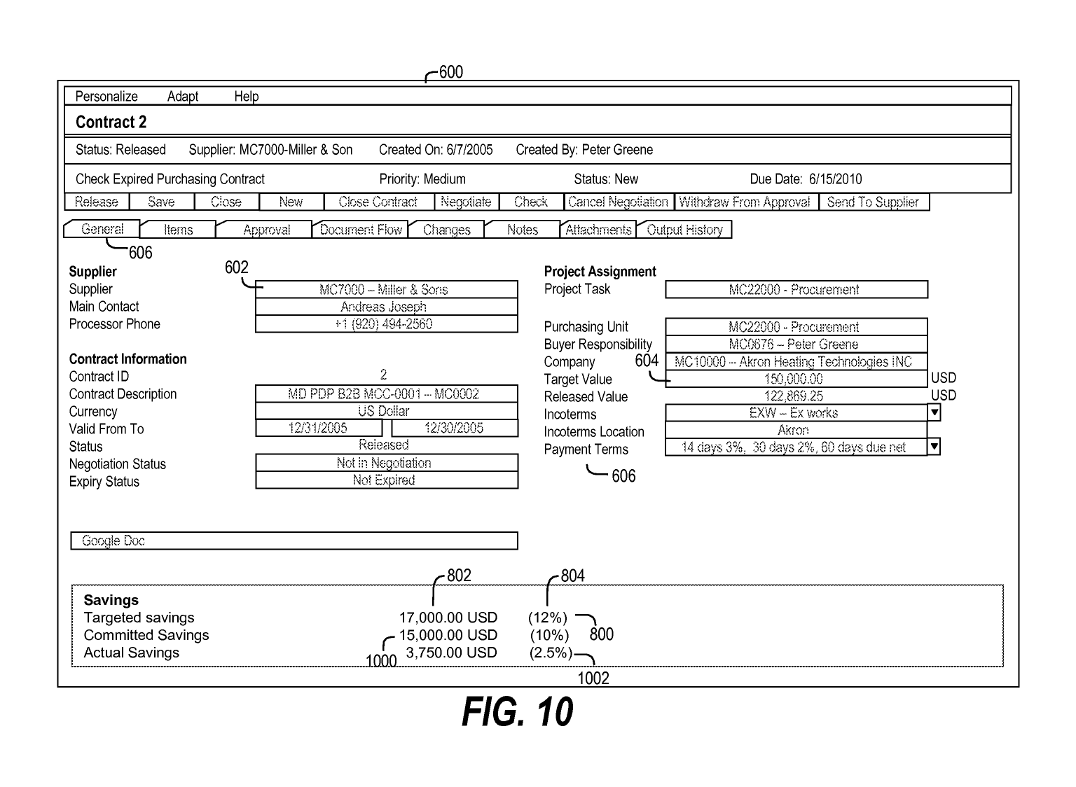

FIG. 10 is a representation of the view 600 in the graphical user interface after storing of committed savings and actual savings in the contract, in accordance with some embodiments.

Referring to FIG. 10, in accordance with some embodiments, the contract now also includes a committed savings 1000 and an actual savings 1002.

In some embodiments, the committed savings and the actual savings are indicated as a monetary amount and/or as a percentage (e.g., compared to the target value 604).

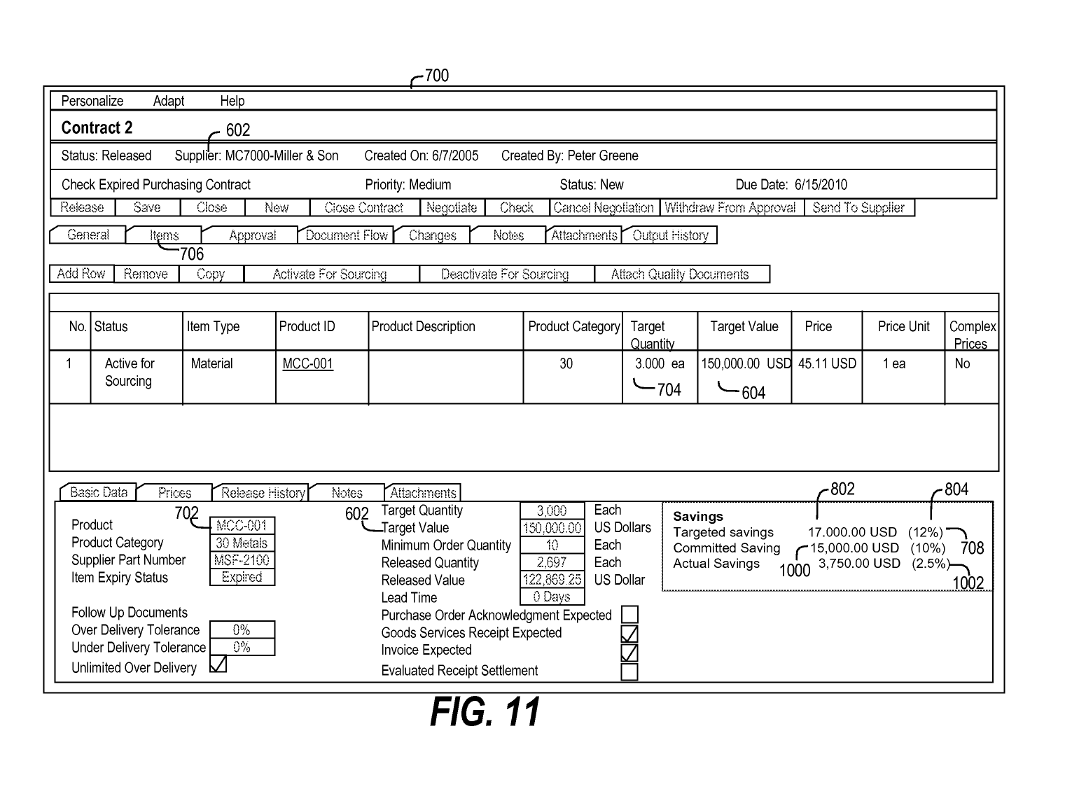

FIG. 11 is a representation of the view 700 in the graphical user interface after storing of committed savings and actual savings in the contract, in accordance with some embodiments.

Referring to FIG. 11, in accordance with some embodiments, the contract now also includes a committed savings 1000 and an actual savings 1002.

In some embodiments, the committed savings and the actual savings are indicated as a monetary amount and/or as a percentage (e.g., compared to the target value 604).

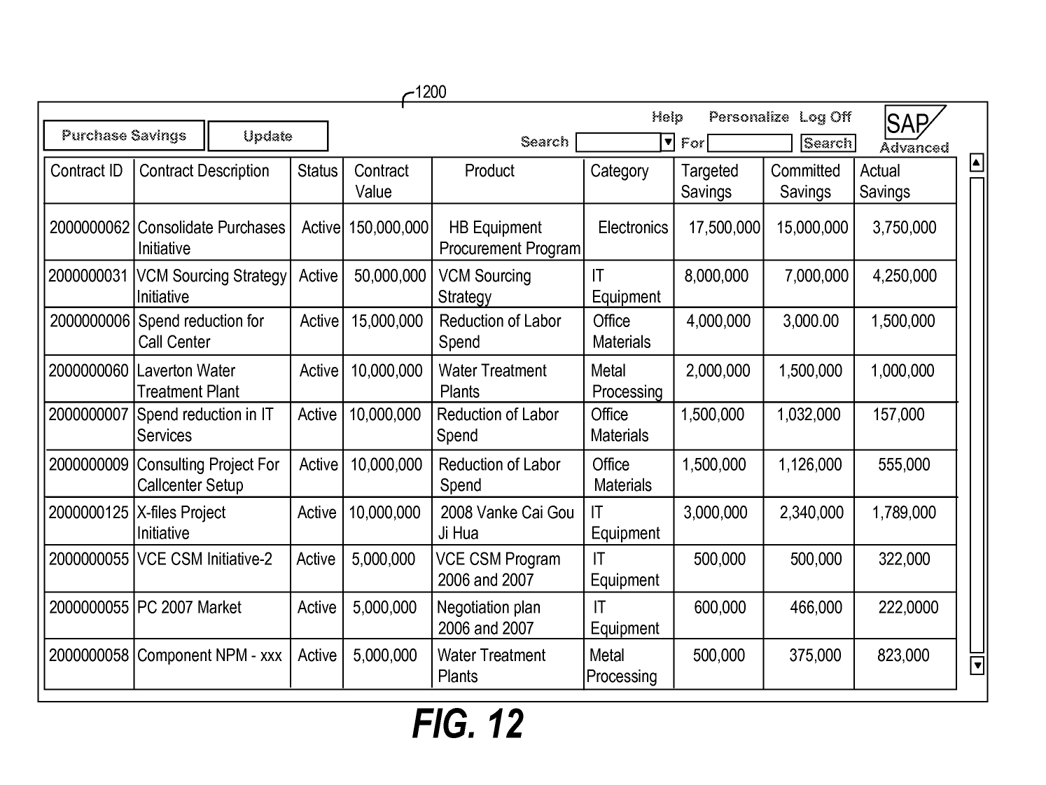

FIG. 12 is a representation of a view 1200 in a graphical user interface showing a portion of a savings report, in accordance with some embodiments. In some embodiments, the information shown in view 1200 may be a summary generated based on a plurality of contracts, purchase orders and/or any other type of purchasing document. In some embodiments, a purchasing document may comprise and/or be in the form of an excel spreadsheet. In some embodiments, the information shown in view 1200 may be stored in an electronic purchasing guide.

Referring to FIG. 12, the report may include a plurality of rows and a plurality of columns. The first row may define a header that includes a plurality of names (e.g., Contract ID, Contract Description, Status, Contract Value, Product, Category, Targeted Savings, Committed Savings, Actual Savings), each of which may be associated with a respective one of the plurality of columns and may indicate the type of information that is listed in the respective one of the plurality of columns.

Each of the other rows may define a line item (sometimes referred to herein as an entry) in the report and may include a Contract ID, Contract Description, Status, Contract Value, Product, Category, Targeted Savings, Committed Savings, Actual Savings.

In some embodiments, for a given row or entry in the table, the Contract ID may indicate a name or other identifier (ID) assigned to a contract, the Contract Value may indicate a target value of the contract, the Product may indicate a name or other identifier of a product associated with the contract, the Category may indicate a name or other identifier of a category with which the product is associated, the Targeted Savings may indicate a target savings (e.g., as a percentage or monetary value) for the contract compared to the Contract Value, the Committed Savings may indicate a committed savings (e.g., as a percentage or monetary value) agreed to by a supplier for the contract compared to the Contract Value, and the Actual Savings may indicate actual savings (e.g., as a percentage or monetary value) for the contract compared to the Contract Value.

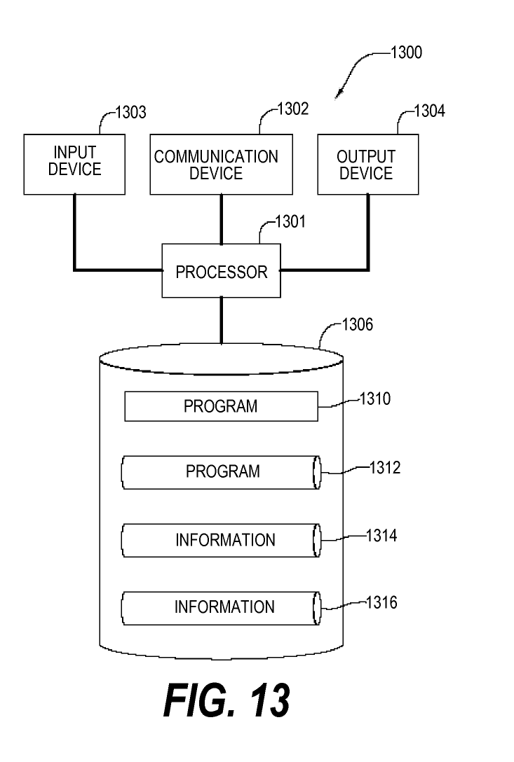

FIG. 13 is a block diagram of an architecture 1300 according to some embodiments. In some embodiments, one or more of the systems and/or processing systems disclosed herein may have an architecture that is the same as and/or similar to the architecture 1300 (or portion(s) thereof). In some embodiments, one or more of the devices disclosed herein may have an architecture that is the same as and/or similar to the architecture 1300 (or portion(s) thereof). In some embodiments, one or more of the methods (or portion(s) thereof) disclosed herein may be performed by systems, apparatus and/or devices having an architecture that is the same as and/or similar to the architecture 1300 (or portion(s) thereof).

Referring to FIG. 13, in accordance with some embodiments, the architecture 1300 includes a processor 1301 coupled to a communication device 1302, an input device 1303, an output device 1304 and a storage device 1306.

In some embodiments, the processor 1301 may execute processor-executable program code to provide or otherwise result in one or more portions of one or more functions and/or one or more portions of one or more methods disclosed herein. In some embodiments, the processor 1301 may comprise one or more INTEL® Pentium® processors.

The communication device 1302 may be used to facilitate communication with other devices and/or systems. In some embodiments, communication device 1302 may comprise an Ethernet and/or other type of connection to a network and/or resource and through which apparatus 1300 may receive and/or transmit information.

The input device 1303 may be used to input information. In some embodiments, the input device 1303 may comprise a keyboard, a keypad, a track ball, a touchpad, a mouse or other pointing device, a microphone, a knob or a switch, an infra-red (IR) port and/or a computer media reader.

The output device 1304 may be used to output information. In some embodiments, the output device 1304 may comprise an IR port, a docking station, a display, a speaker and/or a printer.

The storage device 1306 may store one or more programs 1310-1312 and/or other information for operation of the architecture 1300. In some embodiments, the one or more programs and/or other information may include one or more operating systems, one or more database management systems and/or other applications for operation of the architecture 1300. In some embodiments, the one or more programs 1310-1312 may include one or more instructions to be executed by the processor 1301 to provide one or more portions of one or more functions and/or one or more portions of one or more methods disclosed herein. In some embodiments, the one or more programs and/or other information may include one or more databases 1314-1316.

In some embodiments, the storage device 906 may comprise one or more storage devices, such as, for example, magnetic storage devices (e.g., magnetic tape and/or hard disk drives), optical storage devices, and/or semiconductor memory devices such as Random Access Memory (RAM) devices and Read Only Memory (ROM) devices.

In some embodiments, one or more portions of one or more embodiments disclosed herein may be embodied in a system, a method, an apparatus and/or a computer-readable storage medium.

In some embodiments, one or more (i.e., some or all) portions of any embodiment disclosed herein may be performed by a processor. In some embodiments, one or more portions of any embodiment disclosed herein may result from a processor executing instructions.

In some embodiments, a computer-readable storage medium may store thereon instructions that when executed by a processor result in performance of one or more portions of one or more embodiments disclosed herein.

A computer-readable storage medium may store thereon instructions that when executed by a processor (or multiple processors) result in performance of a process according to any of the embodiments described herein.

In some embodiments, some or all portions of the information described in herein may be stored in one or more storage devices.

Unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively.

Moreover, unless stated otherwise, the term “first” does not, by itself, require that there also be a “second”.

In addition, unless stated otherwise, terms such as, for example, “in response to” and “based on” mean “in response at least to” and “based at least on”, respectively, so as not to preclude being responsive to and/or based on, more than one thing.

In addition, unless stated otherwise, a “user device” may comprise any type of device that may be used by a user. Thus, a user device may have any form factor and may not be owned by and/or assigned to a user. In addition, unless stated otherwise, a “database” may comprise one or more related or unrelated databases.

In addition, unless stated otherwise, data may comprise any type of information and may have and/or be stored in any form. In some embodiments, data may be stored in raw, excerpted, summarized and/or analyzed form. Unless stated otherwise, a processing system may comprise any type of processing system. For example, a processing system may be programmable or non programmable, general purpose or special purpose, dedicated or non dedicated, distributed or non distributed, shared or not shared, and/or any combination thereof. A processing system may include, but is not limited to, hardware, software, firmware, and/or any combination thereof. Hardware may include, but is not limited to off the shelf integrated circuits, custom integrated circuits and/or any combination thereof. In some embodiments, a processing system will include at least one processor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. In some embodiments, a processing system will include at least one processor that executes instructions stored on the computer readable medium. A processing system may employ continuous signals, periodically sampled signals, and/or any combination thereof. If a processor is distributed, two or more portions of the processor may communicate with one another through a communication link.

Unless stated otherwise, a processor may comprise any type of processor. For example, a processor may be programmable or non programmable, general purpose or special purpose, dedicated or non dedicated, distributed or non distributed, shared or not shared, and/or any combination thereof. A processor may include, but is not limited to, hardware, software, firmware, and/or any combination thereof. Hardware may include, but is not limited to off the shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. In some embodiments, a processing may execute instructions stored on the computer readable medium. A processor may employ continuous signals, periodically sampled signals, and/or any combination thereof. If a processor is distributed, two or more portions of the processor may communicate with one another through a communication link.

In addition, unless stated otherwise, a communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols.

While various embodiments have been described, such description should not be interpreted in a limiting sense. It is to be understood that other embodiments may be practiced without departing from the spirit and scope of the invention, as recited in the claims appended hereto.

What is claimed is:

1. A method comprising:
receiving, by a processing system, data indicative of purchasing activities;
displaying, by a processing system, a summary of at least a portion of the purchasing activities;
receiving, by a processing system, a user request to simulate a change to the at least a portion of the purchasing activities;
determining, by a processing system, at least one result of the simulated change to the at least a portion of the purchasing activities;
displaying, by a processing system, the at least one result of the simulated change to the at least a portion of the purchasing activities;
receiving, by a processing system, a user request to store data indicative of the at least one result; and
storing, by a processing system, data indicative of the at least one result in association with the data indicative of the purchasing activities.

2. A method according to claim 1, wherein the at least one result comprises:
an estimate of potential savings from the simulated change to the at least a portion of the purchasing activities; and
wherein the storing comprises:
storing data indicative of the estimate of potential savings in association with the data indicative of the purchasing activities.

3. A method according to claim 1, wherein the data indicative of purchasing activities comprises a data object defining a contract with a supplier; and
wherein the storing comprises:
storing the data indicative of the at least one result in the data object defining the contract with a supplier.

4. A method according to claim 3, wherein the contract with the supplier comprises a target value for the contract,
wherein the at least one result of the simulated change defines a target savings for the contract compared to the target value of the contract; and
wherein the storing comprises:
storing data indicative of the target savings in the data object defining the contract with the supplier.

5. A method according to claim 4, further comprising:
receiving data indicative of committed savings, compared to the target value of the contract, that are agreed to by the supplier; and
storing the data indicative of the amount savings that is agreed to by the supplier in the data object defining the contract with the supplier.

6. A method according to claim 5, further comprising:
receiving data indicative of actual savings over a period of the contract compared to the target value of the contract; and
storing the data indicative of the actual amount saved in the data object defining the contract with the supplier.

7. A method according to claim 6, further comprising:
generating an evaluation based at least in part at least one of the target savings, the committed savings and the actual savings.

8. A method according to claim 6, further comprising:
storing at least one of the target savings, the committed savings and the actual savings in at least one of an electronic purchasing guide, an electronic supplier negotiation document and a human capital management system.

9. A method according to claim 1, wherein the displaying a summary of at least a portion of the purchasing activities comprises:
displaying a plurality of product categories and a plurality of monetary amounts, each of the plurality of monetary amounts being associated with a respective one of the plurality of product categories.

10. A method according to claim 9, further comprising:
determining the plurality of product categories and the plurality of amounts based at least in part on the data indicative of the purchasing activities.

11. A method according to claim 10, further comprising:
receiving, by a processing system, user input indicative of a selected one of the plurality of product categories; and
wherein the displaying a summary of at least a portion of the purchasing activities comprises:
displaying a description of at least one product that is within the selected product category; and
displaying at least one monetary amount that is associated with the at least one product and based on at least in part on the data indicative of the purchasing activities.

12. A method according to claim 11, further comprising:
receiving, by a processing system, user input indicative of a selected one of the at least one product;
determining a plurality of suppliers of the selected product based at least in part on the data indicative of the purchasing activities;
determining a plurality of quantities based at least in part on the data indicative of the purchasing activities, each of the plurality of quantities being associated with a respective one of the plurality of suppliers and being indicative of a quantity of the selected product that is to be procured from the associated supplier;
determining a plurality of prices based at least in part on the data indicative of the purchasing activities, each of the plurality of prices being associated with a respective one of the plurality of suppliers and being indicative of at least one price charged by the associated supplier for the selected product;
displaying data indicative of the plurality of suppliers, the plurality of quantities and the plurality of prices; and
wherein the receiving a user request to simulate a change to the at least a portion of the purchasing activities comprises:
receiving a user request to simulate a change to at least one of the plurality of suppliers, the plurality of quantities and/or the plurality of prices.

13. A computer-readable medium having processor-executable instructions stored thereon, the instructions being executable by a machine to result in a method comprising: receiving, by a processing system, data indicative of purchasing activities; displaying, by a processing system, a summary of at least a portion of the purchasing activities; receiving, by a processing system, a user request to simulate a change to the at least a portion of the purchasing activities; determining, by a processing system, at least one result of the simulated change to the at least a portion of the purchasing activities; displaying, by a processing system, the at least one result of the simulated change to the at least a portion of the purchasing activities; receiving, by a processing system, a user request to store data indicative of the at least one result; and storing, by a processing system, data indicative of the at least one result in association with the data indicative of the purchasing activities.

14. A medium according to claim 13, wherein the at least one result comprises:
an estimate of potential savings from the simulated change to the at least a portion of the purchasing activities; and
wherein the storing comprises:
storing data indicative of the estimate of potential savings in association with the data indicative of the purchasing activities.

15. A medium according to claim 13, wherein the data indicative of purchasing activities comprises a data object defining a contract with a supplier; and
wherein the storing comprises:
storing the data indicative of the at least one result in the data object defining the contract with a supplier.

16. A medium according to claim 15, wherein the contract with the supplier comprises a target value for the contract,
wherein the at least one result of the simulated change defines a target savings for the contract compared to the target value of the contract; and
wherein the storing comprises:
storing data indicative of the target savings in the data object defining the contract with the supplier.

17. A system comprising:
at least one processor to:
receive data indicative of purchasing activities;
display a summary of at least a portion of the purchasing activities;
receive a user request to simulate a change to the at least a portion of the purchasing activities;
determine at least one result of the simulated change to the at least a portion of the purchasing activities;
display the at least one result of the simulated change to the at least a portion of the purchasing activities;
receive a user request to store data indicative of the at least one result; and
store data indicative of the at least one result in association with the data indicative of the purchasing activities.

18. A system according to claim 17, wherein the at least one result comprises:
an estimate of potential savings from the simulated change to the at least a portion of the purchasing activities; and
wherein the at least one processor to store data comprises at least one processor to:
store data indicative of the estimate of potential savings in association with the data indicative of the purchasing activities.

19. A system according to claim 17, wherein the data indicative of purchasing activities comprises a data object defining a contract with a supplier; and
wherein the at least one processor to store data comprises at least one processor to:
store the data indicative of the at least one result in the data object defining the contract with a supplier.

20. A system according to claim 19, wherein the contract with the supplier comprises a target value for the contract,
wherein the at least one result of the simulated change defines a target savings for the contract compared to the target value of the contract; and
wherein the at least one processor to store data comprises at least one processor to:
store data indicative of the target savings in the data object defining the contract with the supplier.
